(19) United States
(12) Patent Application Publication
(10) Pub. No.: US 2013/0160034 A1
(43) Pub. Date: Jun. 20, 2013

(54) POSITIONING STRUCTURE FOR HOLDING OPTICAL DISK DRIVE AND ELECTRONIC DEVICE USING THE SAME

(71) Applicant: HAI-QING ZHOU, Shenzhen (CN)

(72) Inventor: HAI-QING ZHOU, Shenzhen (CN)

(21) Appl. No.: 13/676,087

(22) Filed: Nov. 13, 2012

(30) Foreign Application Priority Data
Dec. 15, 2011 (CN) 201110420548.8

(51) Int. Cl. G11B 33/02

(52) U.S. Cl. CPC G11B 33/022
USPC 720/654

(57) ABSTRACT

A positioning structure for fixing an optical disk drive includes a case and a tray. The case includes a support plate and a cover located on the support plate, a receiving cavity is defined between the support plate and the cover. A groove is defined in the support plate. The tray includes a sidewall and a fixing portion located adjacent to the sidewall. The fixing portion includes a clasp portion, and the clasp portion is received in the groove.

### BACKGROUND

1. Technical field

The disclosure generally relates to a positioning structure for holding an optical disk drive and an electronic device using the positioning structure.

2. Description of the Related Art

An optical disk drive is fixed in an electronic device such as a server with screws. It is very troublesome during assembly or disassembly of the optical disk drive to the electronic device. Additionally, the assembly process also takes too much time. Thus, it is inconvenient for users.

Therefore, there is room for improvement within the art.

### BRIEF DESCRIPTION OF THE DRAWINGS

Many aspects of an exemplary positioning structure and electronic device can be better understood with reference to the following drawings. The components in the drawings are not necessarily drawn to scale, the emphasis instead being placed upon clearly illustrating the principles of the exemplary positioning structure and electronic device. Moreover, in the drawings, like reference numerals designate corresponding parts throughout the several views. Wherever possible, the same reference numbers are used throughout the drawings to refer to the same or like elements of an embodiment.

FIG. 1 is an exploded view of a positioning structure applied in an electronic device, according to an exemplary embodiment.

FIG. 2 is similar to FIG. 1, but shown from another angle.

FIG. 3 is an assembled view of the electronic device shown in FIG. 1.

FIG. 4 is a cross-sectional view along line IV-IV shown in FIG. 3.

FIG. 5 is a cross-sectional view along line V-V shown in FIG. 3.

### DETAILED DESCRIPTION

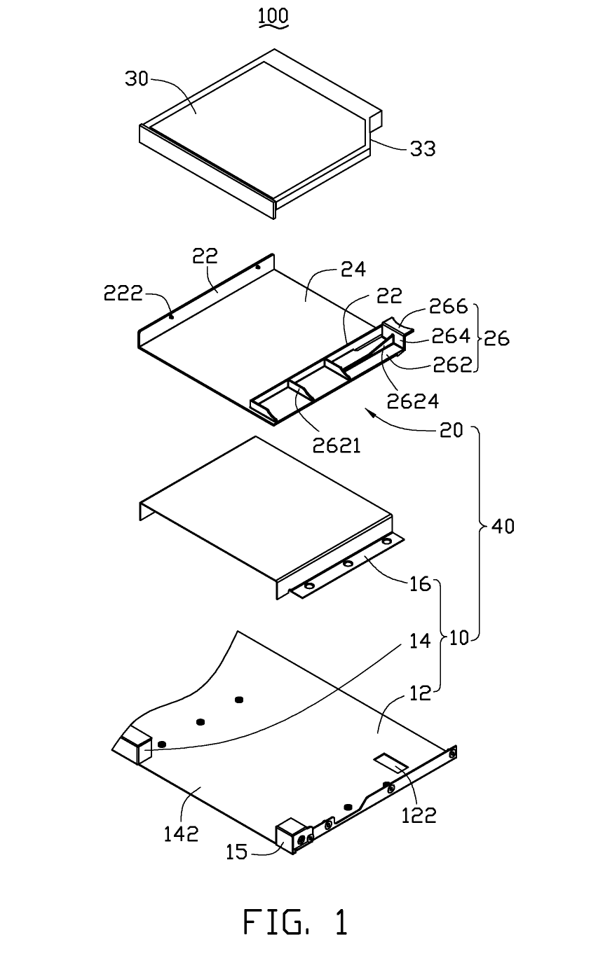

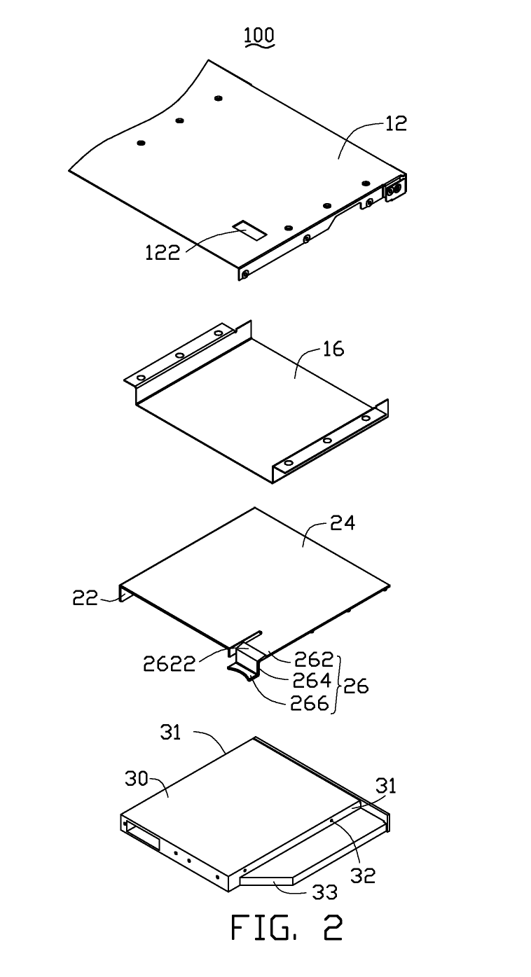

FIG. 1 and FIG. 2 is an electronic device 100 according to an exemplary embodiment. The electronic device 100 can be a server or a computer. In one embodiment, the electronic device 100 is a server. The electronic device 100 includes an optical disk drive 30 and a positioning structure 40, for holding the optical disk drive 30. The positioning structure 40 includes a case 10 and a tray 20, attached to the case 10.

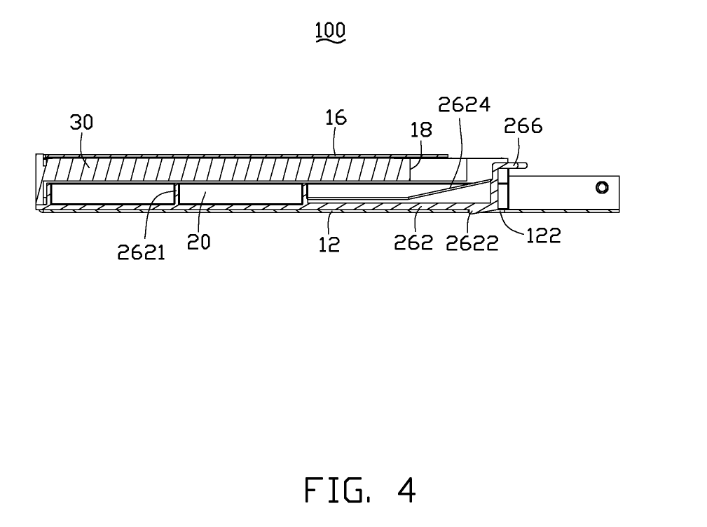

The case 10 can be a portion of the electronic device 100 or be separately formed and then assembled to the electronic device 100. The case 10 includes a support plate 12 and a cover 16, located on the support plate 12. Referring to FIG. 4, a receiving cavity 18 is defined between the support plate 12 and the cover 16. The support plate 12 defines a groove 122 for latching with the tray 20. The support plate 12 includes a first stopper portion 14 and an opposite second stopper portion 15. Two sides of the cover 16 are positioned between the first stopper portion 14 and the second stopper portion 15. An entrance 142 is defined between the first stopper portion 14 and the second stopper portion 15 and is in communication with the receiving cavity 18.

The tray 20 includes two opposite sidewalls 22 and a bottom plate 24 connecting to the two sidewalls 22. A fixing portion 26 is located adjacent to one sidewall 22. Each sidewall 22 includes at least one protrusion 222 extending toward another opposite sidewall 22. The protrusion 222 is made of elastic materials, such as rubber. The fixing portion 26 includes an elastic portion 262, a connection portion 264, and a extending portion 266. The connection portion 264 is perpendicularly connected to the elastic portion 262, and the extending portion 266 perpendicularly protrudes from the connection portion 264. The elastic portion 262 and the extending portion 266 are parallel and offset to each other. The elastic portion 262 is made of elastic materials.

A plurality of ribs 2621 are perpendicularly positioned on the elastic portion 262. The ribs 2621 are parallel to each other and are configured for supporting the optical disk drive 30. A triangle shaped positioning portion 2624 is perpendicularly positioned on the elastic portion 262 and the connection portion 264. The positioning portion 2624 is configured for resisting an inclined surface 33 of the optical disk drive 30. A clasp portion 2622 is located on a surface of the elastic portion 262 and extends along an opposite direction than that of the extending portion 266. The clasp portion 2622 is engaged in the groove 122.

The optical disk drive 30 includes two side surfaces 31, and each side surface 31 defines at least one screw hole 32. The screw holes 32 are standard features of the optical disk drive 30 and are configured for engaging with screws in prior art. In this embodiment, the screw holes 32 are engaged with the protrusions 222.

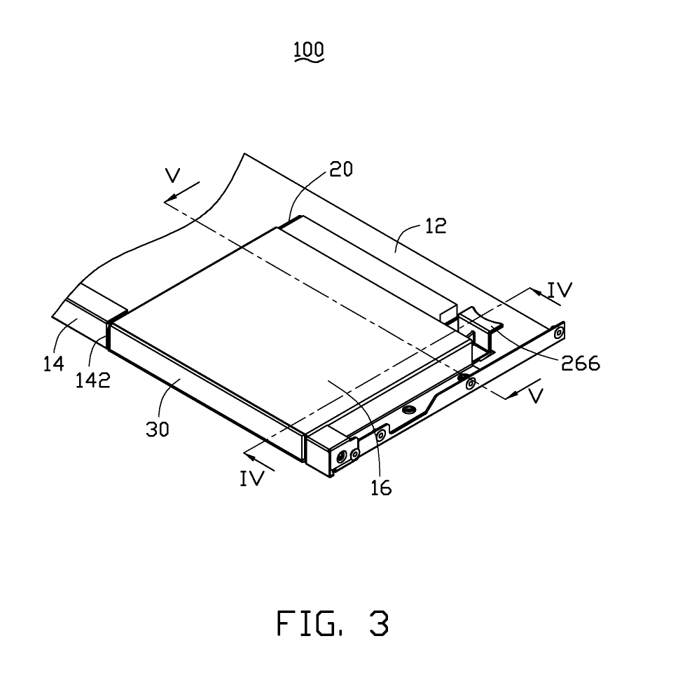

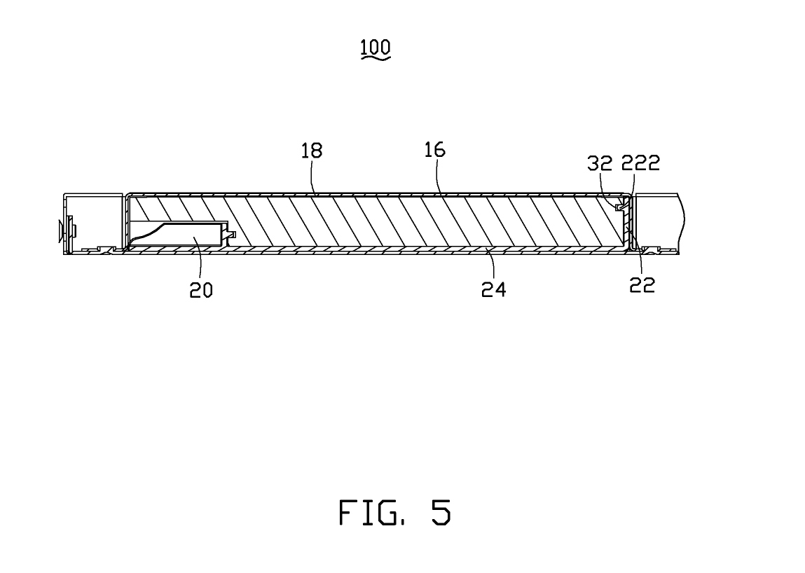

FIG. 3, FIG. 4, and FIG. 5 shows the electronic device 100 being assembled as follows:

The optical disk drive 30 is located on the bottom plate 24, and the protrusions 222 of each sidewall 22 are received in the screw holes 32. The tray 20 with the optical disk drive 30 is inserted into the entrance 142 and is received in the receiving cavity 18. The elastic portion 262 resists the support plate 12 and is deformed. When the clasp portion 2622 is aligned with the groove 122, the elastic portion 262 returns to an original shape and the clasp portion 2622 is received in the groove 122. The electronic device 100 is completely assembled.

If the optical disk drive 30 needs to be taken out of the electronic device 100, the extending portion 266 is pulled away from the support plate 12 until the clasp portion 2622 is moved out of the groove 122. Then the tray 20 with the optical disk drive 30 may be pushed out of the receiving cavity 18.

The electronic device 100 with the optical disk drive 30 is easily assembled and disassembled.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A positioning structure for holding an optical disk drive, the positioning structure comprising:
a case comprising a support plate and a cover located, on the support plate; a receiving cavity defined between the support plate and the cover; and a groove defined in the support plate; and
a tray slidably received in the receiving cavity, the tray comprising a sidewall and a fixing portion located adjacent to the sidewall;
wherein the fixing portion includes a clasp portion, and the clasp portion is received in the groove.

2. The positioning structure as claimed in claim 1, wherein the tray further comprises a bottom plate connecting to the sidewall, and the fixing portion extends from an edge of the bottom plate and is parallel to the sidewall.

3. The positioning structure as claimed in claim 2, wherein the fixing portion comprises an elastic portion, a connection portion, and a extending portion; the connection portion is perpendicularly connected to the elastic portion, the extending portion is perpendicularly extended from the connection portion; the elastic portion and the extending portion are parallel and offset to each other; and the clasp portion is located on a surface of the elastic portion and extends along an opposite direction than that of the extending portion.

4. The positioning structure as claimed in claim 3, wherein the support plate includes a first stopper portion and a second stopper portion that are opposite to each other, and an entrance is defined between the first stopper portion and the second stopper portion and is in communication with the receiving cavity.

5. An electronic device, comprising:
a case comprising a support plate and a cover located on the support plate, a receiving cavity defined between the support plate and the cover, a groove defined in the support plate;
a tray slidably received in the receiving cavity, the tray comprising a sidewall and a fixing portion located adjacent to the sidewall; and
an optical disk drive mounted on the tray;
wherein the fixing portion includes a clasp portion, the clasp portion is received in the groove.

6. The electronic device as claimed in claim 5, wherein the tray further comprises a bottom plate connecting to the sidewall, the fixing portion is extended from an edge of the bottom plate and is parallel to the sidewall.

7. The electronic device as claimed in claim 6, wherein the fixing portion comprises a elastic portion, a connection portion, and a extending portion; the connection portion is perpendicularly connected to the elastic portion, the extending portion is perpendicularly extended from the connection portion; the elastic portion and the extending portion are parallel and offset to each other; the clasp portion is located on a surface of the elastic portion, and extends along a reverse direction relative to the extending portion.

8. The electronic device as claimed in claim 7, wherein the support plate includes a first stopper portion and a second stopper portion opposite to each other, an entrance is defined between the first stopper portion and the second stopper portion and is in communication with the receiving cavity.
